(19) United States
(12) Patent Application Publication
(10) Pub. No.: US 2024/0348683 A1
(43) Pub. Date: Oct. 17, 2024

(54) STORAGE SYSTEM AND STORAGE MANAGEMENT METHOD

(71) Applicant: Hitachi, Ltd., Tokyo (JP)

(72) Inventors: Misato YOSHIDA, Tokyo (JP); Takahiro YAMAMOTO, Tokyo (JP); Katsuto SATO, Tokyo (JP); Akira YAMAMOTO, Tokyo (JP); Yoshinori OHIRA, Tokyo (JP)

(21) Appl. No.: 18/461,726

(22) Filed: Sep. 6, 2023

(30) Foreign Application Priority Data
Apr. 11, 2023 (JP) 2023-064213

(51) Int. Cl. H04L 67/1012; H04L 67/1008; H04L 67/1097

(52) U.S. Cl. CPC H04L 67/1012; H04L 67/1008; H04L 67/1097

(57) ABSTRACT

An object is to effectively use resources of a plurality of storage nodes.

A storage system includes a plurality of storage nodes. The storage system includes: a management unit configured to manage the plurality of storage nodes. Each of the plurality of storage nodes is configured to accumulate credits on a condition that a processing load is within a predetermined range and perform burst in which processing is performed with a load exceeding the predetermined range by consuming the credits. The management unit manages the credits of each storage node, determines a trigger of burst of predetermined storage processing based on an accumulation state of the credits in the plurality of storage nodes related to the storage processing, and executes, when the credits are accumulated in the plurality of storage nodes related to the predetermined storage processing, the predetermined storage processing by the burst by consuming the accumulated credits.

### BACKGROUND OF THE INVENTION

### 1. Field of the Invention

The present invention relates to a storage system and a storage management method.

### 2. Description of Related Art

Servers (virtual machines) in a cloud environment have been provided with various specifications. For example, a small-sized virtual machine that can be used at a low cost has a burst function that can temporarily improve a performance. Such a virtual machine can cope with a case in which a load is usually small but temporarily increased.

PTL 1 discloses a burst in a storage system. PTL 1 discloses that “a maximum IOPS parameter is the maximum sustained IOPS value over an extended period of time. The max burst IOPS parameter is the maximum IOPS value that a client can “burst” above the maximum IOPS parameter for a short period of time based upon credits. In one implementation, credits for a client are accrued when the client is operating under their respective maximum IOPS parameter.”.

### CITATION LIST

### Patent Literature

PTL 1: 2015-507268A

### SUMMARY OF THE INVENTION

According to PTL 1, a burst function is managed by a concept of the credits. The credits are accumulated in a use situation lower than a predetermined baseline, and burst beyond the baseline can be performed. When the burst is performed, the use situation is higher than the baseline, and thus the credits are consumed. When the credits are exhausted, a maximum usable value returns to the baseline.

A case in which a storage system is configured with a server having such a burst function is considered. As described above, since a time or a timing at which the burst can be used is limited, a method is conceivable in which a performance of an IO that is constant processing is designed based on the baseline, and the accumulated credits are used in a situation in which resources are additionally required at a time of failure or the like.

Here, since a trigger and the time at which the burst can be performed are limited, an object is to appropriately perform burst trigger determination in a storage system and effectively use resources of a plurality of storage nodes.

To achieve the object, one of representative storage systems according to the invention is a storage system including a plurality of storage nodes. The storage system includes a management unit configured to manage the plurality of storage nodes. Each of the plurality of storage nodes is configured to accumulate credits on a condition that a processing load is within a predetermined range and perform burst in which processing is performed with a load exceeding the predetermined range by consuming the credits. The management unit manages the credits of each storage node, determines a trigger of burst of predetermined storage processing based on an accumulation state of the credits in the plurality of storage nodes related to the storage processing, and executes, when the credits are accumulated in the plurality of storage nodes related to the predetermined storage processing, the predetermined storage processing by the burst by consuming the accumulated credits.

Further, one of representative storage management methods according to the invention is a storage management method of a storage system including a plurality of storage nodes. The storage management method includes: accumulating, by each of the plurality of storage nodes, credits on a condition that a processing load is within a predetermined range; managing, by a management unit configured to manage the plurality of storage nodes, the credits of each storage node; determining, by the management unit, a trigger of burst of predetermined storage processing based on an accumulation state of the credits in the plurality of storage nodes related to the storage processing; and executing, by the management unit, the predetermined storage processing by burst in which processing is performed with a load exceeding the predetermined range by consuming, when the credits are accumulated in the plurality of storage nodes related to the predetermined storage processing, the accumulated credits.

According to the invention, it is possible to effectively use resources of a plurality of storage nodes. Problems, configurations, and effects other than those described above will be clarified by the following description of embodiments.

### BRIEF DESCRIPTION OF THE DRAWINGS

FIG. 1 shows a configuration of a storage system;

FIG. 2 shows a storage node and burst portions;

FIG. 3 shows examples of a baseline performance and a burst performance;

FIG. 4 shows an example of NW burst;

FIG. 5 shows memory information of the storage node;

FIG. 6 shows burst management information;

FIG. 7 shows NW burst management information;

FIG. 8 shows BE burst management information;

FIG. 9 shows CPU burst management information;

FIG. 10 is a flowchart of burst time management processing;

FIG. 11 is a flowchart of asynchronous processing;

FIG. 12 is a schematic diagram of a second embodiment 2 (burst FO destination node);

FIG. 13 is a flowchart of failover processing including burst;

FIG. 14 shows an example of a VOL burst setting;

FIG. 15 shows storage monitor information; and

FIG. 16 is a flowchart of VOL rebalance processing based on credits.

### DESCRIPTION OF EMBODIMENTS

Hereinafter, several embodiments according to the invention will be described with reference to the drawings. In the drawings, a “volume” is referred to as a “VOL”. The volume is a logical storage space managed by a storage system.

“NW” indicates a network, “BE” indicates a backend, and “FO” indicates a failover.

A virtual machine in a cloud environment is referred to as an instance.

A description “node” indicates a storage node.

### First Embodiment

In a first embodiment, a case in which burst is applied in storage asynchronous processing different from a constant IO will be described.

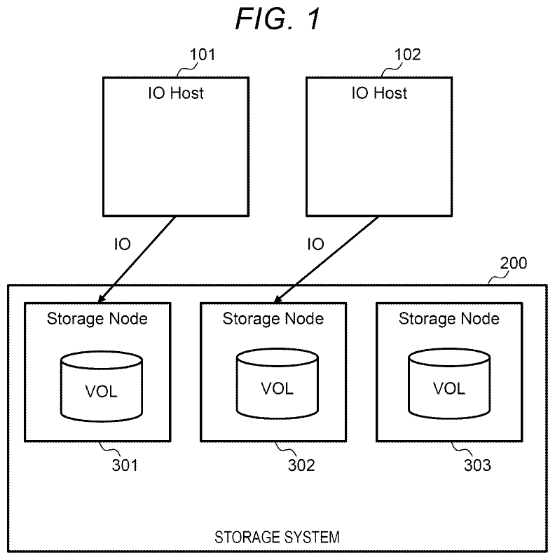

FIG. 1 shows a configuration of the storage system.

One or more storage nodes constitute the storage system. In FIG. 1, storage nodes 301 to 303 constitute a storage system 200. In the invention, the storage node is a server in which an upper limit of a network bandwidth and an upper limit of a CPU usage rate change. For example, there is a virtual machine in a cloud environment.

IO (input/output of data) is performed from an IO host to the volume in the storage node. The network connects between the storage nodes and between the IO host and the storage nodes. In FIG. 1, an IO host 101 performs the IO to a volume of the storage node 301. Similarly, an IO host 102 performs the IO to a volume of the storage node 302.

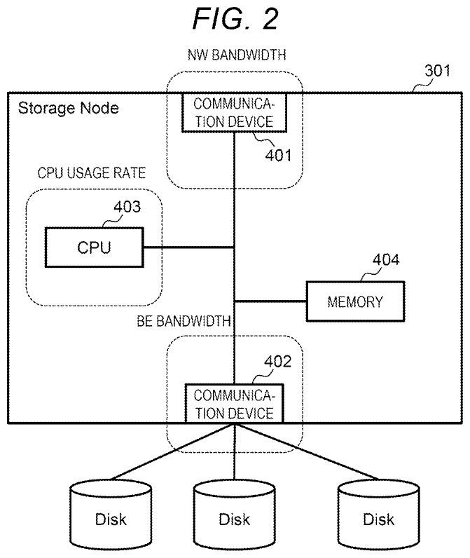

FIG. 2 shows the storage node and burst portions.

The storage node 301 shown in FIG. 2 includes a communication device 401, a communication device 402, a central processing unit (CPU) 403, and a memory 404.

Via the network, the communication device 401 communicates with the IO host 101 and communicates with other storage nodes (the storage node 302 and the storage node 303). A communication bandwidth of the communication device 401 is referred to as an NW bandwidth.

The communication device 402 communicates with disks each being a backend storage device. A communication bandwidth of the communication device 402 is referred to as a BE bandwidth.

In the present embodiment, for example, a case in which a server in which portions indicated by dotted lines (the NW bandwidth, the CPU usage rate, and the BE bandwidth) burst is applied to the storage node will be described. The invention is also applicable to a server in which other portions such as a memory and a disk burst. In the present example, the number of the CPUs is one for simplification of explanation, and a plurality of the CPUs may be provided. In this case, the burst may be performed for each CPU. A plurality of the communication devices 401 and a plurality of the communication device 402 may be provided. For example, a total usage bandwidth of the plurality of communication devices 401 may be managed as a usage network bandwidth of the storage node.

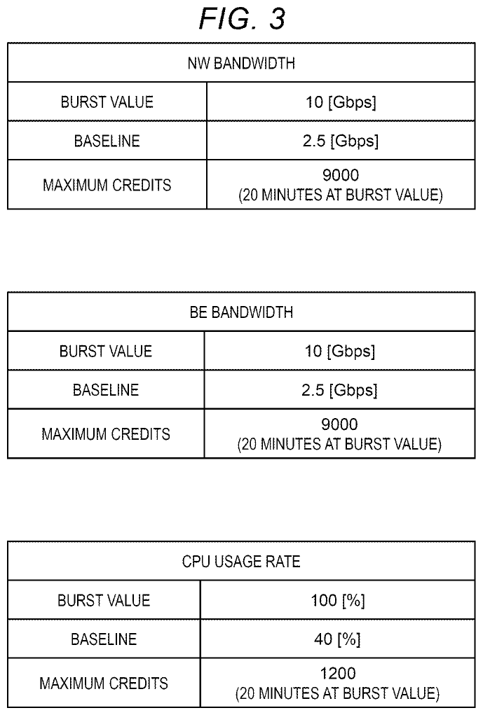

FIG. 3 shows examples of a baseline performance and a burst performance in the burst portions.

Values are examples, and vary depending on the cloud environment and instance types.

A burst value, a baseline, and maximum credits shown in FIG. 3 are as follows.

Burst value: A maximum value capable of bursting beyond the baseline

Baseline: A balance value at which consumption and accumulation of the credits by usage are zero. When resources exceeding the baseline are used, the credits are consumed, and when resources below the baseline are used, the credits are accumulated. When the credits are accumulated, the burst beyond the baseline can be performed.

Maximum Credits: Maximum credits that can be accumulated

A method for calculating the credits and the maximum credits differ depending on the cloud environment and the instance types. For example, in the present example, the maximum credits of 9000 of the network bandwidth is an amount that can be used for 20 minutes when the burst value of 10 Gbps is used. When a bandwidth smaller than the burst value is used, the burst (a bandwidth exceeding the baseline) can be used for a time larger than 20 minutes.

In the present example, the method for calculating the credits is based on “the baseline−a current usage value”, but another formula according to a specification of the cloud environment may be used. According to the calculation method, the farther the amount of resources from the baseline is used, the greater the consumption and accumulation of credits are.

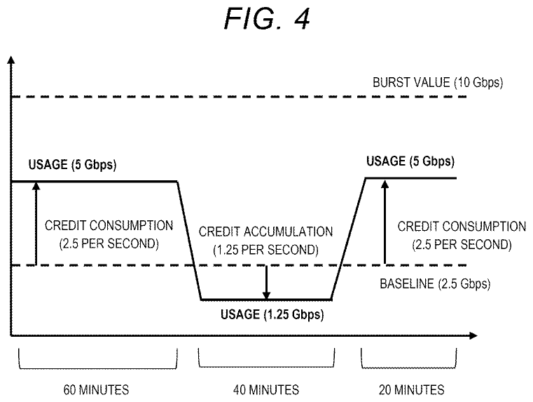

FIG. 4 shows an example of network burst.

FIG. 4 shows an example of the burst and the consumption and accumulation of the credits in the network bandwidth specifications in FIG. 3.

For example, when 5 Gbps, which exceeds 2.5 Gbps of the baseline, is used, a credit calculation formula is 2.5 (baseline)−5=−2.5, and credits of 2.5 are consumed per second. When the credits of 9000 are accumulated before the usage, the credits are 0 in 9000/2.5=3600 seconds=60 minutes. That is, 5 Gbps can be used for 60 minutes, but after that, the credits are 0, and the burst beyond the baseline cannot be performed. (In another example, when 10 Gbps is used, the credits consumption per second is 7.5, and 10 Gbps can be used for 20 minutes)

Thereafter, when 1.25 Gbps below the baseline is used, the credit calculation formula is 2.5 (baseline)−1.25=1.25, and credits of 1.25 are accumulated per second. For example, when 1.25 Gbps is used for 40 minutes, the credits of 1.25×40×60=3000 are accumulated. Since the credits are accumulated, the burst beyond the baseline can be performed again.

Thereafter, when 5 Gbps exceeding the baseline is used, 2.5 (baseline)−5=−2.5, and the credits of 2.5 are consumed per second. Since credits of 3000 are accumulated, the credits are 0 in 3000/2.5=1200 seconds=20 minutes. That is, 5 Gbps can be used for 20 minutes, but after that, the credits are 0, and the burst beyond the baseline cannot be performed.

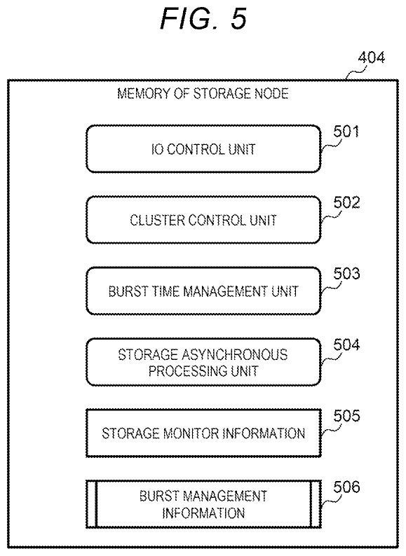

FIG. 5 shows memory information of the storage node.

In the memory 404 of the storage node 301, an IO control unit 501, a cluster control unit 502, a burst time management unit 503, a storage asynchronous processing unit 504, storage monitor information 505, and burst management information 506 are loaded.

The IO control unit 501 performs IO control from the IO host 101 to the volume in the storage system 200.

The cluster control unit 502 performs activation and monitoring of clusters, a failover at a time of a failure, management of volumes, control of management operations from users, and the like.

Processing flowcharts of the burst time management unit 503 and the storage asynchronous processing unit 504 will be described later.

The burst management information 506 will be described later.

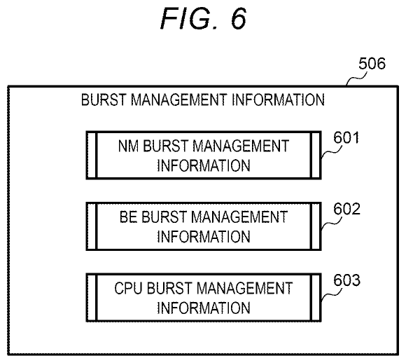

FIG. 6 shows burst management information.

The burst management information 506 stores information on the credits and a burst time for each burst portion to be managed. FIG. 6 shows network (NW) burst management information 601, backend (BE) burst management information 602, and CPU burst management information 603. The NW burst management information 601, the BE burst management information 602, and the CPU burst management information 603 are examples, and there may be information on other portions. Details of each piece of information will be described later.

The burst time management unit 503 stores the pieces of information. A processing unit such as the storage asynchronous processing unit 504 that performs the burst refers to the pieces of information.

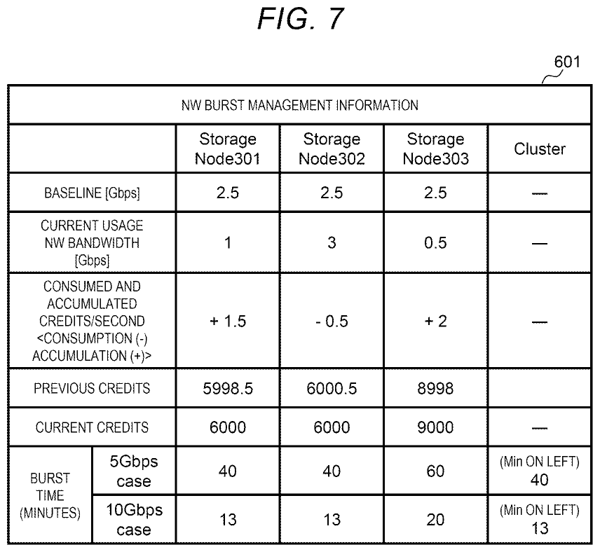

FIG. 7 shows the NW burst management information 601.

The burst time management unit 503 stores the NW burst management information 601. A processing unit such as the storage asynchronous processing unit 504 that performs the burst refers to the NW burst management information 601. The NW burst management information 601 includes the following information.

Baseline: A balance value at which consumption and accumulation of the credits by usage are zero, and which is determined by a specification of the cloud environment or a specification of the instance.

Current usage NW bandwidth: Current value being used by the storage node

Consumed and accumulated credits: Credits consumed and accumulated per second from the current usage NW bandwidth, and calculated according to the specification of the cloud environment. In the present example, “the baseline−the current usage NW bandwidth” is used.

Previous credits: Credits calculated in a previous cycle

Current credits: “Previous credits+consumed and accumulated credits”

Burst time: a time to burst by using the current credits. The larger the bandwidth to be used is, the faster the credit consumption is, and the shorter the time to burst is. For example, in the example of the storage node 301, the burst can be performed at 5 Gbps for 40 minutes and at 10 Gbps for 13 minutes.

A calculation method is as follows. When the burst is performed by 5 Gbps, the credits of 5−2.5 (baseline)=2.5 are consumed per second. When the current credits of 6000 is divided by 2.5, a result thereof is 2400, and the burst can be performed for 2400 seconds. That is, the burst can be performed for 40 minutes.

When the burst is performed by 10 Gbps, the credits of 10−2.5 (baseline)=7.5 are consumed per second. When calculation is performed in the same way, the burst time is 13 minutes.

Burst time (Cluster): Time during which a cluster can burst. For example, a minimum value between nodes is stored as a value at which the nodes can perform the burst in common.

Values when the burst is performed at 5 Gbps and 10 Gbps are stored in the burst time, and values in other cases such as a case of performing the burst at 3 Gbps may be stored. In addition, a value multiplied by a coefficient as a margin may be stored.

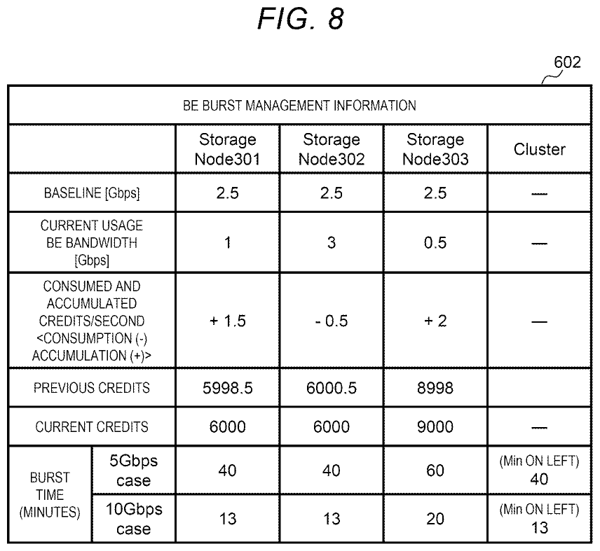

FIG. 8 shows the BE burst management information 602.

This is the same way of thinking as the network burst management information, and description thereof is omitted.

A value to be stored is different from that in the network burst management information. For simplification of explanation, the same value is used in the present example.

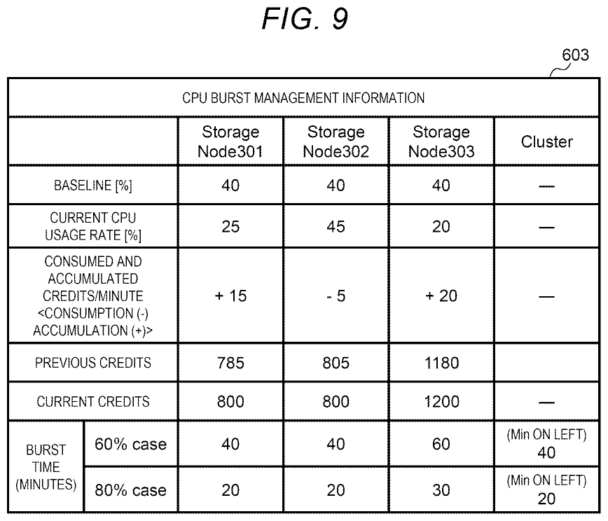

FIG. 9 shows the CPU burst management information 603.

Only a difference from the network burst management information is described.

Consumed and accumulated credits: Credits consumed and accumulated per minute based on a current CPU usage rate, and is calculated according to the specification of the cloud environment. In the present example, “the baseline−the current CPU usage rate” is used to obtain a value in units of minutes.

Burst time: A time to burst by using the current credits. The larger the CPU usage rate is, the faster the credit consumption is, and the shorter the time to burst is. For example, in the example of the storage node 301, the burst can be performed at a usage rate of 60% for 40 minutes and at a usage rate of 80% for 20 minutes.

A calculation method is as follows. When the burst is performed at the usage rate of 60%, the credits of 60−40 (baseline)=20 are consumed per minute. When the current credits of 800 are divided by 20, a result thereof is 40, and the burst can be performed for 40 minutes.

When the burst is performed at a usage rate of 80%, the credits of 80−40 (baseline)=40 are consumed per minute. When calculation is performed in the same way, the burst time is 20 minutes.

Values, when the burst is performed at 60% and 80%, are stored in the burst time, and values in other cases such as a case of performing the burst at 50% may be stored. In addition, a value multiplied by a coefficient as a margin may be stored.

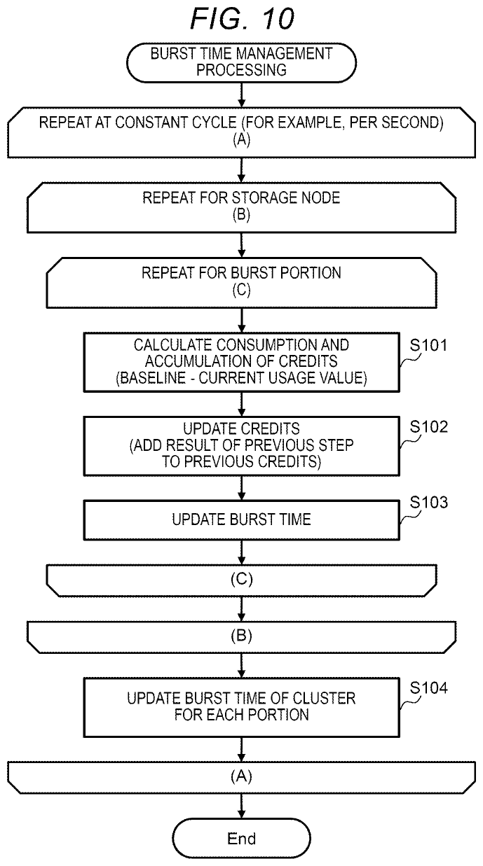

FIG. 10 shows a flowchart of burst time management processing.

The burst time management processing is performed by the burst time management unit 503.

The burst management information is updated for each storage node and each burst portion. Further, the burst time of the cluster is also updated based on a result thereof.

Specifically, the burst time management unit 503 repeats a step of calculating the consumption and accumulation of the credits (S101), a step of updating the credits (S102), and a step of updating the burst time (S103) for each burst portion (C). The burst time management unit 503 repeats the processing repeated for each burst portion (C) for each storage node (B). Further, the burst time management unit 503 repeats the processing repeated for each storage node (B) at a constant cycle (A).

For example, when a currently used network bandwidth of the storage node 301 is 1 Gbps and the previous credits are 5998.5, the following flow is performed.

Consumption and accumulation of credits: The baseline−the current usage value=2.5−1=1.5

Update the credits (add a result of a previous step to previous credits): 5998.5+1.5=6000

“6000” is stored in the current credits.

Update burst time: The current credits of 6000 are converted into the burst time. The burst time is 40 minutes in a case of 5 Gbps. The burst time is 13 minutes in a case of 10 Gbps. (A calculation formula refers to the description of the burst time in FIG. 7.)

Update the burst time of the cluster for each portion: As a result of the processing flow, it is assumed that the burst time in FIG. 7 is updated in each storage node. At this time, the burst time of the cluster stored in the network burst management information is as follows. 5 Gbps case is Min(40, 40, 60)=40 minutes. 10 Gbps case is Min(13, 13, 20)=13 minutes. (A calculation formula refers to the description of the burst time (Cluster) in FIG. 7.)

This means that the burst can be performed for 40 minutes when 5 Gbps is used and 13 minutes when 10 Gbps is used in the entire cluster.

The backend burst management information in FIG. 8 and the CPU burst management information in FIG. 9 are also updated by the same method.

The burst time of each node and the cluster is updated, and a burst time for each combination of nodes may be stored and updated. (For example, in a case of a combination of the storage node 301 and the storage node 302, the burst time is N minutes.)

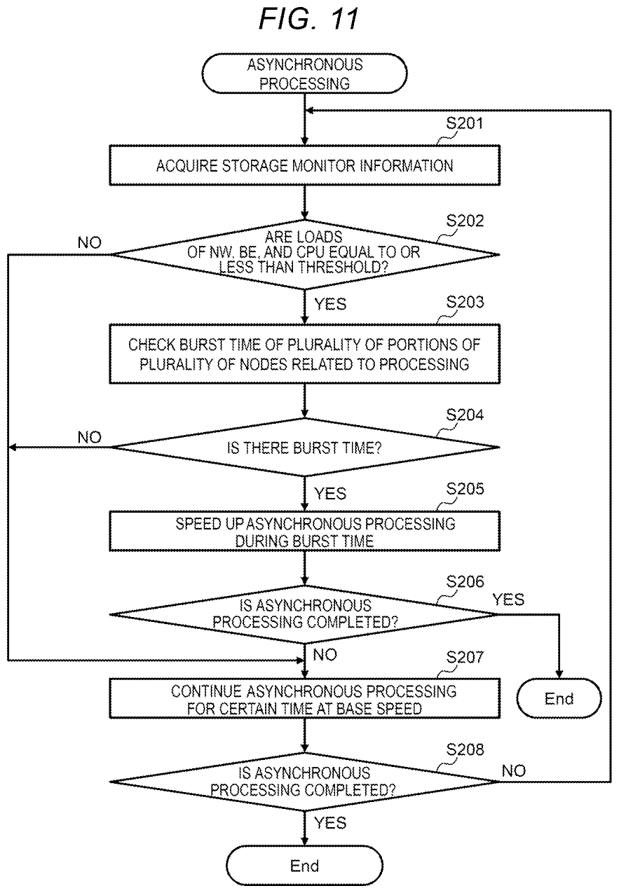

FIG. 11 shows a flowchart of the storage asynchronous processing.

The storage asynchronous processing unit 504 performs the processing.

The storage asynchronous processing unit 504 acquires the storage monitor information 505 (step S201), and determines whether loads on the network, the backend, and the CPU are equal to or less than a threshold (step S202).

If the loads are equal to or less than the threshold (Yes in step S202), the burst time of a plurality of portions is checked for a plurality of nodes related to the processing (step S203). If there is a burst time (Yes in step S204), the asynchronous processing is speeded up during the burst time (step S205). If the asynchronous processing is completed (Yes in step S206), the processing is ended.

If the loads exceed the threshold (No in step S202), if there is no burst time (No in step S204), or the asynchronous processing after the burst is not completed (No in step S206), the storage asynchronous processing unit 504 continues the asynchronous processing for a certain time at a base speed (step S207). If the asynchronous processing is completed (Yes in step S208), the processing is ended. If the asynchronous processing is not completed (No in step S208), the processing returns to step S201.

Examples of the storage asynchronous processing include rebuild processing in which data arrangement is changed when a storage node or a disk fails.

In the processing flow, when the loads are equal to or less than the threshold and the burst time due to the credit accumulation is ensured, the asynchronous processing is speeded up. After the asynchronous processing is speeded up, the credits are consumed, and the asynchronous processing is returned to the base speed. According to the method, for example, the use of the network bandwidth is shown in FIG. 4.

The load and the burst time are checked for a target node (both a transmission side and a reception side) of the asynchronous processing. For example, in a case of processing related to the storage node 301 and the storage node 302, two nodes are checked.

To check the burst time, the burst management information 506 is used to check resources required by the burst in the asynchronous processing. For example, a case in which the asynchronous processing is rebuilt and a burst of the NW bandwidth up to 5 Gbps and a burst of the BE bandwidth up to 5 Gbps are required in the storage nodes 301 and 302 will be described as follows.

According to the NW burst management information 601, when 5 Gbps is used, both the storage nodes 301 and 302 can perform the burst for 40 minutes. According to the BE burst management information 602, when 5 Gbps is used, both the storage nodes 301 and 302 can burst for 40 minutes. Accordingly, the burst time is 40 minutes. During the burst time, for example, the number of processing threads is increased to speed up the processing.

Thereafter, the asynchronous processing is returned to the base speed, and the credit accumulation is performed. For example, when the NW bandwidth and the BE bandwidth are used at 1.25 Gbps, the credits of 3000 are accumulated in 40 minutes (Refer to FIG. 4).

The credits are enough for the burst at 5 Gbps for 20 minutes (Refer to FIG. 4).

Therefore, after the asynchronous processing is continued at the base speed for 40 minutes, the asynchronous processing is speeded up for 20 minutes.

### Second Embodiment

In a second embodiment, a case in which burst is applied when a load is biased to a specific storage node at a time of failure will be described.

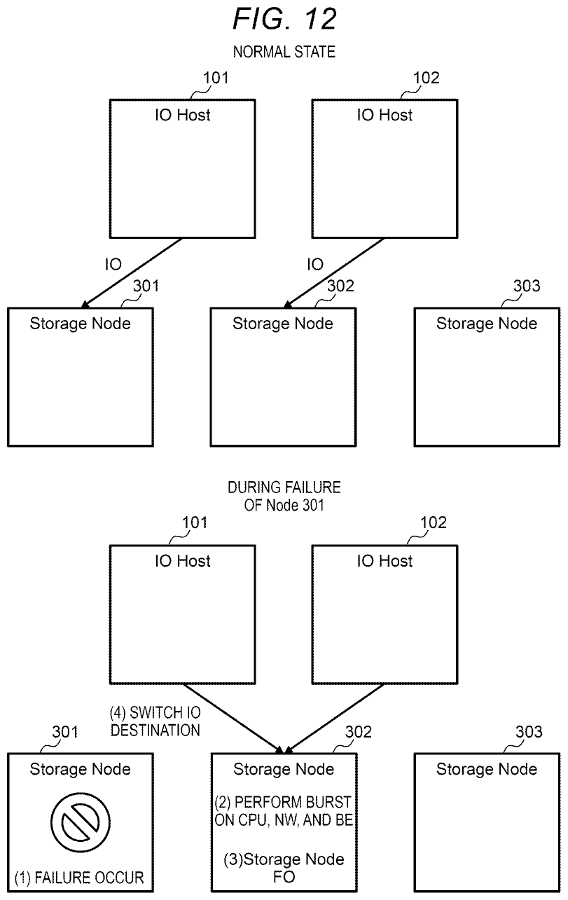

FIG. 12 is a schematic diagram of the second embodiment (performing burst on failover destination node).

First, in a normal state, the IO host 101 performs an IO to a volume of the storage node 301. Similarly, the IO host 102 performs the IO to a volume of the storage node 302.

When the failure occurs in the storage node 301 (1), another storage node (for example, the storage node 302) takes over IO processing of the IO host 101. Accordingly, an IO load of the storage node 302 is increased.

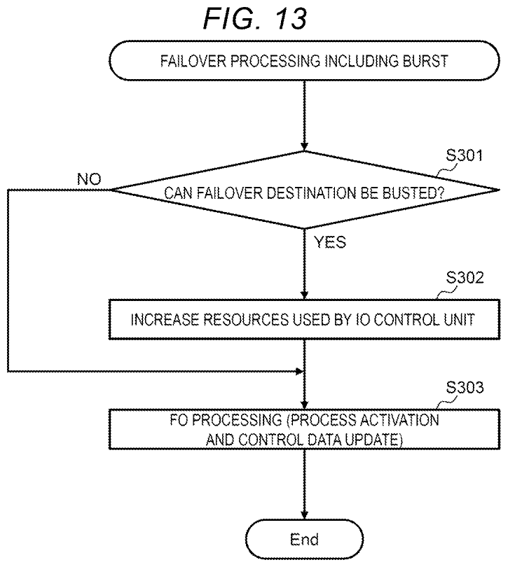

To prevent a decrease in an IO performance of the storage node 302, the IO control unit 501 performs control to use a value for bursting each unit (CPU, NW, and BE) (2). Then, the failover of the storage node is executed (3). A processing flow will be described with reference to FIG. 13.

FIG. 13 shows a flowchart of failover processing including burst.

The cluster control unit 502 performs the processing.

If a failover destination is in a burstable state (Yes in step S301), the cluster control unit 502 increases resources used by the IO control unit 501 (step S302). For example, a CPU usage rate is set to 80% larger than a baseline, and an NW bandwidth and a BE bandwidth are set to 10 Gbps larger than the baseline.

The burst management information 506 is used to determine whether the burst can be performed. For example, when the failover destination is the storage node 302, it is checked that a value is stored in a burst time of the storage node 302. In the case of FIGS. 7 to 9, since values are stored in fields of CPU usage rate 80%, NW bandwidth 10 Gbps, and BE bandwidth 10 Gbps, the burst can be performed under such a resource condition. When the burst cannot be performed under a desired condition, the condition may be lowered to re-determine whether the burst can be performed.

When the resources are increased in step S302, FO processing (step S303) is performed with the increased resources. If the burst cannot be performed (No in step S301), the FO processing (step S303) is performed with normal resources. The FO processing includes process activation and update of control data.

Even when the resources are increased, the burst can be performed for a certain period. Therefore, a resource usage amount is returned to a normal level after a certain period. For example, when the storage node 302 performs the burst with a CPU usage rate of 80%, an NW bandwidth of 10 Gbps, and a BE bandwidth of 10 Gbps, a time during which the burst can be performed is 13 minutes based on FIGS. 7 to 9.

### Third Embodiment

In a third embodiment, a case in which burst is applied to some volumes managed by a storage system will be described.

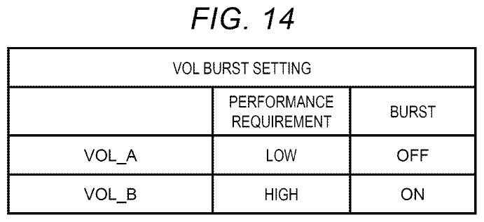

FIG. 14 shows an example of a volume burst setting.

The burst is also applied to an IO according to a performance requirement of the VOL. In an IO to a VOL having a low performance requirement, a flow rate is controlled so as not to use the burst, and credits are accumulated. A VOL having a high performance requirement is not subjected to flow rate control, and the burst can be performed therein.

The performance requirement is set by a user, and burst ON/OFF is automatically set based on the performance requirement or set by the user.

A VOL whose burst setting is ON is allocated to a storage node in which the most credits are accumulated because consumption of resources is expected.

### Fourth Embodiment

In a fourth embodiment, when burst is applied to some volumes managed by a storage system, a case in which a volume is moved to another storage node in a credit state will be described.

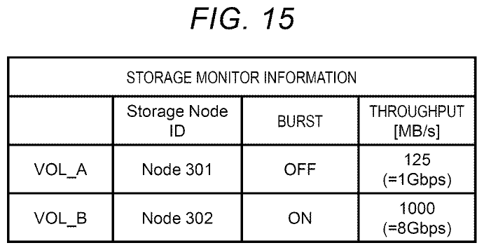

FIG. 15 shows the storage monitor information 505.

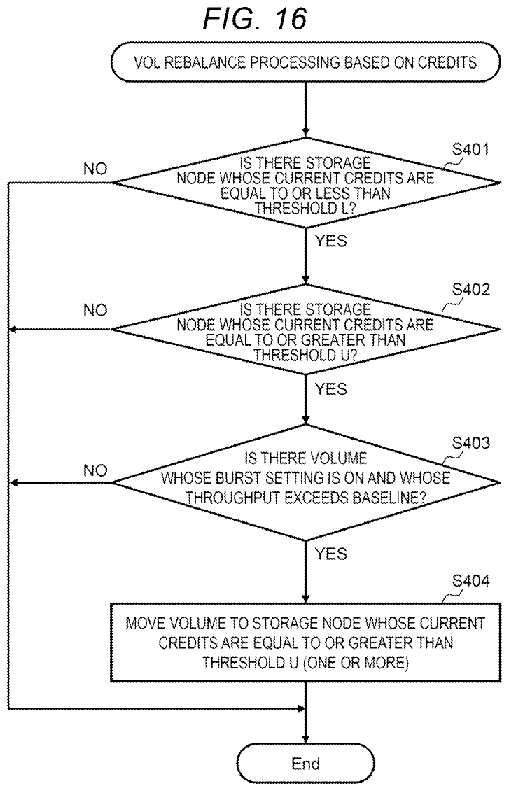

The information is stored in the cluster control unit 502, and is referred to in volume (VOL) rebalance processing based on the credits in FIG. 16.

FIG. 15 shows VOL information of the storage monitor information 505. There may be other statistical values relating to the VOL. The storage monitor information 505 also includes information other than the VOL, but description thereof is omitted. As shown in FIG. 15, the storage monitor information 505 includes the following information.

Storage Node ID: Storage node that manages the VOL

Burst: Burst setting information in FIG. 14

Throughput: Data flow rate to the VOL per second

FIG. 16 shows a flowchart of the VOL rebalance processing based on credits.

The cluster control unit 502 performs the processing.

First, the cluster control unit 502 determines whether there is a storage node whose current credits are equal to or less than a threshold L (step S401). If there is no storage node whose current credits are equal to or less than the threshold L (No in step S401), the processing is ended immediately.

If there is a storage node whose current credits are less than or equal to the threshold L (Yes in step S401), the cluster control unit 502 determines whether there is a storage node whose current credits are equal to or greater than a threshold U (step S402). If there is no storage node whose current credits are equal to or greater than the threshold U (No in step S402), the processing is ended immediately.

If there is a storage node whose current credits are equal to or greater than the threshold U (Yes in step S402), the cluster control unit 502 determines whether there is a volume whose burst setting is ON and whose throughput exceeds the baseline (step S403). If there is no volume whose burst setting is ON and whose throughput exceeds the baseline (No in step S403), the processing is ended immediately.

If there is a volume whose burst setting is ON and whose throughput exceeds the baseline (Yes in step S403), the cluster control unit 502 moves the volume to the storage node whose current credits are equal to or greater than the threshold U (step S404) and ends the processing.

According to the processing, when there is a VOL having large resource consumption due to the burst setting ON on a storage node whose credits are likely to be depleted, the VOL is moved to a storage node having sufficient credits.

One VOL having largest resource consumption may be moved, or a plurality of VOLs may be moved.

The burst portion used for the credit determination is freely set. For example, the BE bandwidth is used.

For example, a case is considered in which the current credits of the BE burst management information of the storage node 302 is 1650 and the current credits of the BE burst management information of the storage node 303 is 9000. A credit depletion threshold (threshold L) is 1700, and the threshold U is 5000.

In this case, according to FIG. 15, in a VOL_B managed by the storage node 302, a burst setting is ON and a throughput exceeds the baseline (2.5 Gbps). Therefore, the VOL_B is moved to the storage node 303 having sufficient credits (the current credits are equal to or greater than the threshold U of 5000).

Accordingly, the VOL_B requiring a burst performance can continue to burst.

Although several embodiments have been described above, these embodiments are merely examples for describing the invention and are not intended to limit the scope of the invention only to these embodiments. For example, any two or more of the above-described embodiments may be combined. In addition, the exemplified calculation formulas and values are examples and do not limit the invention.

As described above, the system disclosed above is the storage system 200 including a plurality of storage nodes 301 to 303. The storage system 200 includes a management unit configured to manage the plurality of storage nodes. Each of the plurality of storage nodes is configured to accumulate credits on a condition that a processing load is within a predetermined range (baseline) and perform burst in which processing is performed with a load exceeding the predetermined range by consuming the credits. The management unit manages the credits of each storage node, determines a trigger of burst of predetermined storage processing based on an accumulation state of the credits in the plurality of storage nodes related to the storage processing, and executes, when the credits are accumulated in the plurality of storage nodes related to the predetermined storage processing, the predetermined storage processing by the burst by consuming the accumulated credits.

In this way, by determining the trigger of the burst based on credit states of the plurality of storage nodes related to the processing, it is possible to effectively use the resources of the plurality of storage nodes.

However, the embodiment describes a configuration in which the storage node functions as a management unit as an example, and a management device including the management unit may be provided separately from the storage node.

The management unit compares the processing load of each storage node with the corresponding predetermined range, updates the credits of each storage node based on a comparison result, calculates, based on the updated credits, a time during which the burst is able to be performed, and determines the trigger of the burst of the predetermined storage processing based on the time during which the burst is able to be performed.

Therefore, it is possible to determine the trigger of the burst by using a time during which the burst is able to be performed as an index.

The management unit continues the predetermined storage processing with a processing load within the predetermined range after the consumption of the credits, and performs the burst again after the credits are accumulated.

Therefore, efficient processing can be implemented even when the credits are exhausted before predetermined storage processing is ended.

The predetermined storage processing is, for example, asynchronous processing.

Further, the management unit starts the predetermined storage processing when a load for processing a request from the IO hosts 101 and 102 is equal to or less than a threshold.

Therefore, it is possible to quickly perform the asynchronous processing while avoiding an influence on the IO processing.

Further, whether the burst is able to be performed may be determined and the asynchronous processing may be started when the burst is able to be performed.

The predetermined storage processing is, for example, rebuild of the storage node.

In this case, the storage system disclosed above can quickly complete the rebuild by using the burst.

Further, the burst is processing in which a load on at least one of a calculation device, communication with a host, and communication with a storage device exceeds the predetermined range.

In this way, the storage system disclosed above can perform the burst for any resource.

When the burst at a plurality of portions needs to be performed, a minimum value of the credits of each portion may be taken. Which portion is required is determined by the processing.

Further, when the credits are accumulated in a storage node that is a failover destination, the management unit performs the processing with the load exceeding the predetermined range when the storage node which is the failover destination processes a request from a host.

In this case, the storage system disclosed above can perform the failover while avoiding the influence on the IO processing.

Further, the management unit is configured to set whether to perform the burst for a plurality of volumes according to a performance requirement.

The management unit gives priority to a storage node having a large accumulated amount of the credits when determining an allocation destination of a volume set to be burstable.

In this way, according to the storage system disclosed above, when there is a performance difference between the volumes, it is possible to allocate the volumes according to the performance difference and the amount of accumulated credits and to make the processing of the entire storage system efficient.

Further, the management unit moves a volume from a storage node having a small accumulation amount of the credits to a storage node having a large accumulation amount of the credits.

In this way, according to the storage system disclosed above, it is possible to rebalance the volumes.

What is claimed is:

1. A storage system including a plurality of storage nodes, the storage system comprising:
a management unit configured to manage the plurality of storage nodes, wherein
each of the plurality of storage nodes is configured to accumulate credits on a condition that a processing load is within a predetermined range and perform burst in which processing is performed with a load exceeding the predetermined range by consuming the credits,
the management unit
manages the credits of each storage node,
determines a trigger of burst of predetermined storage processing based on an accumulation state of the credits in the plurality of storage nodes related to the storage processing, and
executes, when the credits are accumulated in the plurality of storage nodes related to the predetermined storage processing, the predetermined storage processing by the burst by consuming the accumulated credits.

2. The storage system according to claim 1, wherein
the management unit compares the processing load of each storage node with the corresponding predetermined range, updates the credits of each storage node based on a comparison result, calculates, based on the updated credits, a time during which the burst is able to be performed, and determines the trigger of the burst of the predetermined storage processing based on the time during which the burst is able to be performed.

3. The storage system according to claim 1, wherein
the management unit continues the predetermined storage processing with a processing load within the predetermined range after the consumption of the credits, and performs the burst again after the credits are accumulated.

4. The storage system according to claim 1, wherein
the predetermined storage processing is asynchronous processing.

5. The storage system according to claim 4, wherein
the management unit starts the predetermined storage processing when a load for processing a request from a host is equal to or less than a threshold.

6. The storage system according to claim 1, wherein
the predetermined storage processing is rebuilt of the storage node.

7. The storage system according to claim 1, wherein
the burst is processing in which a load on at least one of a calculation device, communication with a host, and communication with a storage device exceeds the predetermined range.

8. The storage system according to claim 1, wherein
when the credits are accumulated in a storage node that is a failover destination, the management unit performs the processing with the load exceeding the predetermined range when the storage node which is the failover destination processes a request from a host.

9. The storage system according to claim 1, wherein
the management unit is configured to set whether to perform the burst for a plurality of volumes according to a performance requirement.

10. The storage system according to claim 9, wherein
the management unit gives priority to a storage node having a large accumulated amount of the credits when determining an allocation destination of a volume set to be burstable.

11. The storage system according to claim 1, wherein
the management unit moves a volume from a storage node having a small accumulation amount of the credits to a storage node having a large accumulation amount of the credits.

12. A storage management method of a storage system including a plurality of storage nodes, the storage management method comprising:
accumulating, by each of the plurality of storage nodes, credits on a condition that a processing load is within a predetermined range;
managing, by a management unit configured to manage the plurality of storage nodes, the credits of each storage node;
determining, by the management unit, a trigger of burst of predetermined storage processing based on an accumulation state of the credits in the plurality of storage nodes related to the storage processing; and
executing, by the management unit, the predetermined storage processing by burst in which processing is performed with a load exceeding the predetermined range by consuming, when the credits are accumulated in the plurality of storage nodes related to the predetermined storage processing, the accumulated credits.
